(19) United States
(12) Patent Application Publication
(10) Pub. No.: US 2014/0132446 A1
(43) Pub. Date: May 15, 2014

(54) METHOD AND APPARATUS FOR DETECTING CROSS CORRELATION BASED IN LIMITED RANGE CODE PHASE OFFSET OBSERVATIONS

(71) Applicant: Gary Lennen, Cupertino, CA (US)

(72) Inventor: Gary Lennen, Cupertino, CA (US)

(73) Assignee: Cambridge Silicon Radio Limited, Cambridge (GB)

(21) Appl. No.: 14/126,517

(22) PCT Filed: Jun. 15, 2011
(86) PCT No.: PCT/US11/40416

§ 371 Date: Dec. 16, 2013

(51) Int. Cl. G01S 19/13

(52) U.S. Cl. CPC G01S 19/13
USPC 342/357.51

(57) ABSTRACT

Apparatus and a method identify and eliminate false satellite signals that are cross correlation signals without prior knowledge of any possibly interfering strong satellite signals. The disclosed method analyzes a small number of code phase offsets relative to a threshold value based on the detected peak of a weak satellite signal to determine if the weak satellite signal is not a true satellite autocorrelation signal but a cross-correlation signal. The number of code phase offsets and the threshold value may be determined based on the signal-to-noise ratio of the detected weak satellite signal.

The present application concerns satellite navigation systems and, in particular, the determination of the erroneous detection of cross-correlation signals as satellite signals.

### BACKGROUND

In satellite positioning systems, cross correlation between a strong received satellite signal a weak satellite signal may prevent the coarse acquisition (C/A) code of a weak satellite signal may cause the global navigation satellite system (GNSS) to erroneously acquire and track the cross correlation signal as a satellite. This problem may occur where only a small number of strong satellite signals are available and the GNSS receiver acquires a weak satellite signal and then, during tracking erroneously switches to track the cross correlation signal as the weak satellite signal. Past systems have attempted to mitigate cross correlation in order to acquire/track weak satellite signals.

Past methods of cross correlation mitigation have included the classic post correlation subtraction method or the subspace projection method. The post correlation subtraction method typically relies on computing the cross correlation signature of the weak satellite C/A spreading code with a generated signal representing the strong satellite to be mitigated. The generated signal typically uses the carrier phase, carrier frequency, and code phase obtained from tracking the strong satellite to estimate the received strong satellite signal. The correlation signature is then scaled by the estimated strong satellite amplitude and subtracted from the correlation of the received signal with the weak satellite C/A code. Alternatively, in the subspace projection method the correlation signature may be compared against a threshold and the weak satellite C/A code may be modified for received signal correlation so as to reduce the cross correlation of the strong satellite signal with the modified C/A and to enable the weak satellite signal to be acquired/tracked.

Both the post correlation subtraction method and the subspace projection method require significant circuitry in the GNSS device. In addition, they may suffer from poor mitigation performance in dynamic environments. The correlation signature is sensitive to errors in the estimates of the amplitude and phase of the strong satellite signal. Estimate of the satellite parameters may not be accurate due to changing Doppler frequency shifts and fading that often occur in dynamic environments. In the subspace projection method, a different C/A code would have to be derived for each code phase position used in the correlation signature. Integration of the modified C/A code into the correlation with the received signal is also complicated to implement due to the code phase dependency of the correlation signature.

A significant disadvantage of prior methods of cross correlation detection is that they require the receiver to have knowledge of the existence of the strong interfering satellites.

### SUMMARY

The embodiments described below identify and eliminate false satellite signals that are cross correlation signals without prior knowledge of any possibly interfering strong satellite signals. The example method analyzes correlation signals for a small number of code phase offsets relative to a detected peak of a weak satellite signal to determine if the weak satellite signal is not a true satellite signal but a cross-correlation signal. These correlation signals are compared to a threshold value derived from the peak value. If one of these correlation signals exceeds the threshold value then the peak is determined to be a false peak.

### BRIEF DESCRIPTION OF THE DRAWINGS

FIGS. 1A and 1B are graphs of correlation amplitude versus chip delay that are useful for describing the operation of an example embodiment of the invention.

FIG. 2 is a graph of correlation amplitude versus chip delay that shows an example autocorrelation characteristic.

FIG. 3 is a graph of correlation amplitude versus chip delay that shows an example cross correlation characteristic.

FIG. 4 is a graph of correlation amplitude versus chip delay that shows an example cross correlation characteristic in the presence of a carrier frequency offset.

FIGS. 5, 6 and 7 are graphs of number of chip offsets versus code chip number that are useful for describing the operation of an example embodiment of the invention.

FIG. 8 is a block diagram of a GPS receiver that is suitable for use with an example embodiment of the invention.

FIG. 9A is a graph of correlation peak magnitude versus chip delay that is useful for describing the operation of an example embodiment of the invention.

FIG. 9B, 9C and 10 are flow-chart diagrams that are useful for describing example embodiments of the invention.

### DETAILED DESCRIPTION

Cross correlation can cause false locking on to a strong satellite while the GNSS receiver is searching for a weak satellite. Satellite signals of the Global Positioning System (GPS) use a 1023-bit pseudo-random noise (PRN) spreading codes that repeat every millisecond. The particular PRN codes used by GPS satellites are Gold Codes. These codes exhibit good cross correlation properties. In particular with zero carrier offset for the respective satellite signals, cross correlation between any two GPS signals is limited to about −24 dB with respect to the main autocorrelation peak. With the addition of carrier frequency offset in the range of ±5 kHz, however, cross correlation signals that are −20 db or less below the autocorrelation peak may be detected. While the invention is described in terms of a GPS system, it is contemplated that it may be practiced with other GNSS systems such as GLONASS, Galileo and Beidou. In addition, the subject invention may have applications outside of GNSS. It may be used, for example, to identify false correlations between non-orthogonal PRN codes, for example in code division multiple access (CDMA) receivers.

In practice, two satellite signals may have respective autocorrelation signal peaks that differ by 20 dB or more. As this is in the range of a cross-correlation signal from a strong satellite signals and the locally generated C/A code of the weak satellite, it is possible that this cross-correlation may be erroneously detected as a particular desired satellite signal.

Cross correlation can also result in a GNSS receiver that is tracking a combination of a strong satellite signal and a weak local code representation that is used to receive signals from a weak satellite. A particularly problematic cross correlation problem exists when the receiver has no knowledge of the existence of the strong signal causing the cross correlation. An example of this is the Quasi-Zenith Satellite System (QZSS), launched by the Japanese government. QZSS transmits an L1 C/A-code compatible signal. The L1 C/A code has two forms, one that is a predefined standard code for that satellite and another non-standard C/A code transmitted during satellite testing. The standard code is a PRN code that exhibits low cross correlation with GPS signals. The non-standard C/A code, however exhibits larger cross correlation that may be in the range of 20 dB below the peak autocorrelation signal of a strong satellite. Correlation signals in this range may be erroneously identified as GPS satellites by a GPS system.

If a receiver knows of a strong satellite signal, it may acquire and track that satellite and use algorithms such as those described above to predict and mitigate any cross-correlation distortion caused by the strong satellite signal. In many circumstances, a receiver will not know about a newly transmitted signal. Examples include receivers that were designed before this newly transmitted signal was conceived.

Tracking a strong signal emanating from a previously unknown transmitter can lead to erroneous position measurements because, due to the cross-correlation of the PRN codes, the receiver has mistaken the unknown satellite signal for the C/A code of a known satellite. This false lock onto an unknown satellite signal can result in position errors of hundreds of kilometers.

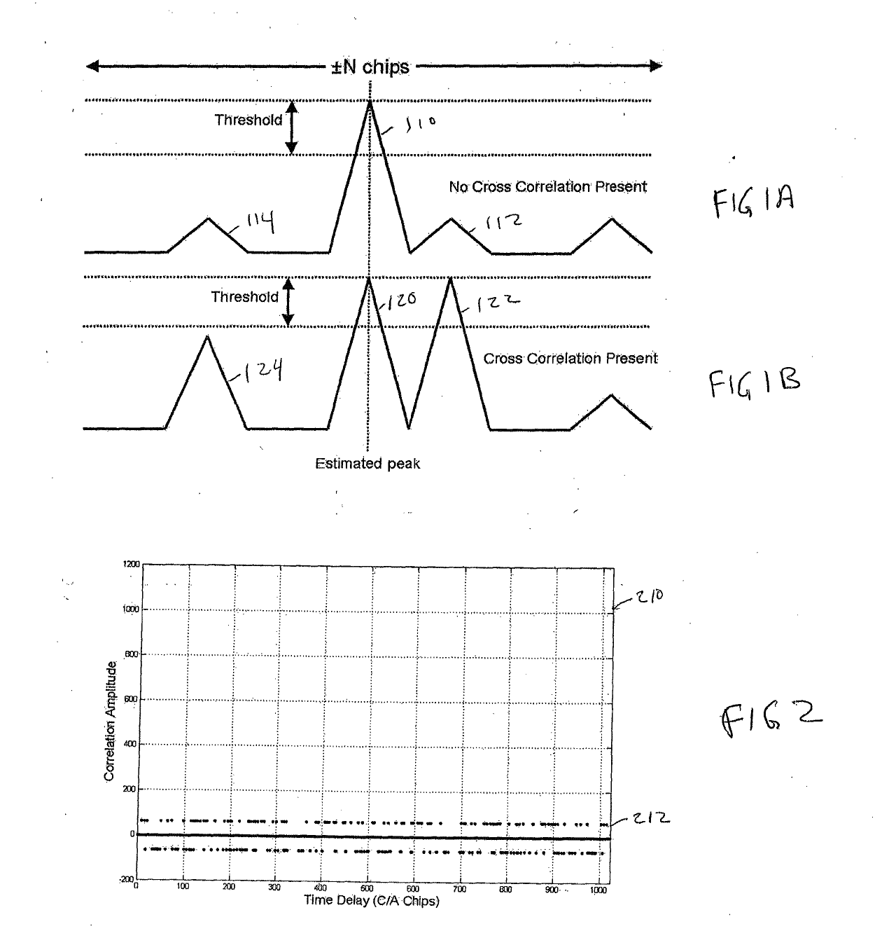

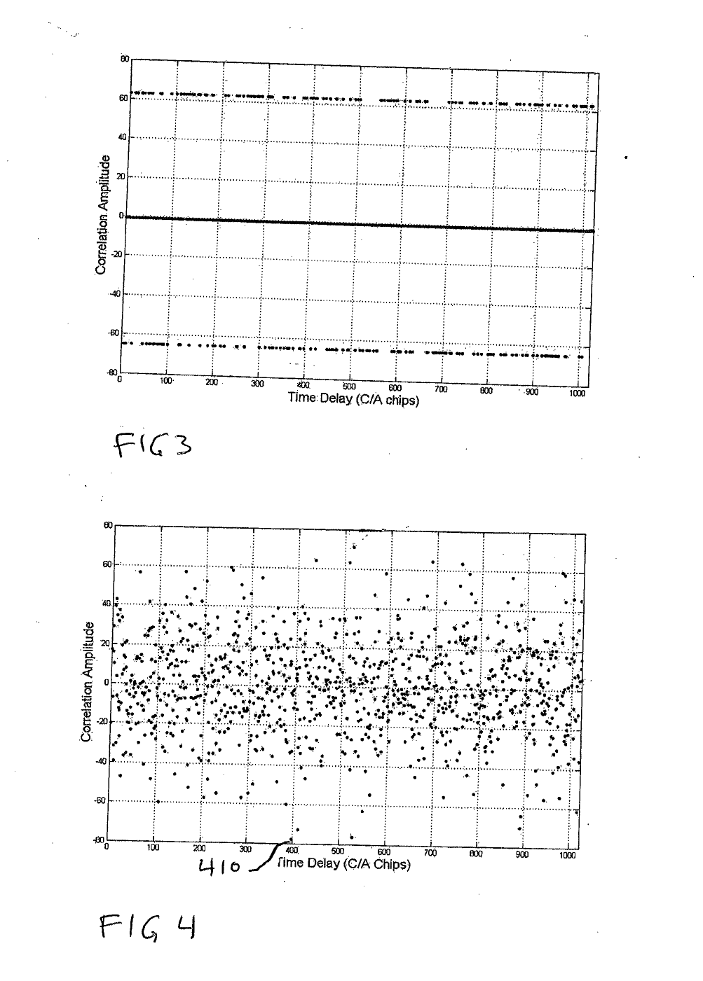

The inventor has determined that a false lock onto a strong satellite signal having a frequency offset or to an unknown satellite signal due to cross correlation between the PRN of the cross correlation signal and a true C/A code can be detected by analyzing the power of the correlated signal at ±N chip offsets from the estimated peak. FIG. 1A shows a correlation with autocorrelation characteristics while FIG. 1B shows a correlation with cross correlation characteristics. As can be seen in FIG. 1A, the autocorrelation peak 110 has a much greater magnitude than peaks 112 and 114 at code phases separated by only a few chips of the C/A code.

The inventor has determined that this is not the case for a false correlation caused by cross correlation of a known C/A code with the interfering signal of a strong satellite or of an unknown satellite. As can be seen from FIG. 1B, the cross correlation is not limited to a single dominant estimated peak 120 but may exhibit other peaks (e.g. peak 112) that are within a threshold magnitude of any estimated peak. If a lower threshold is used, other peaks, for example, peak 124, may also be detected.

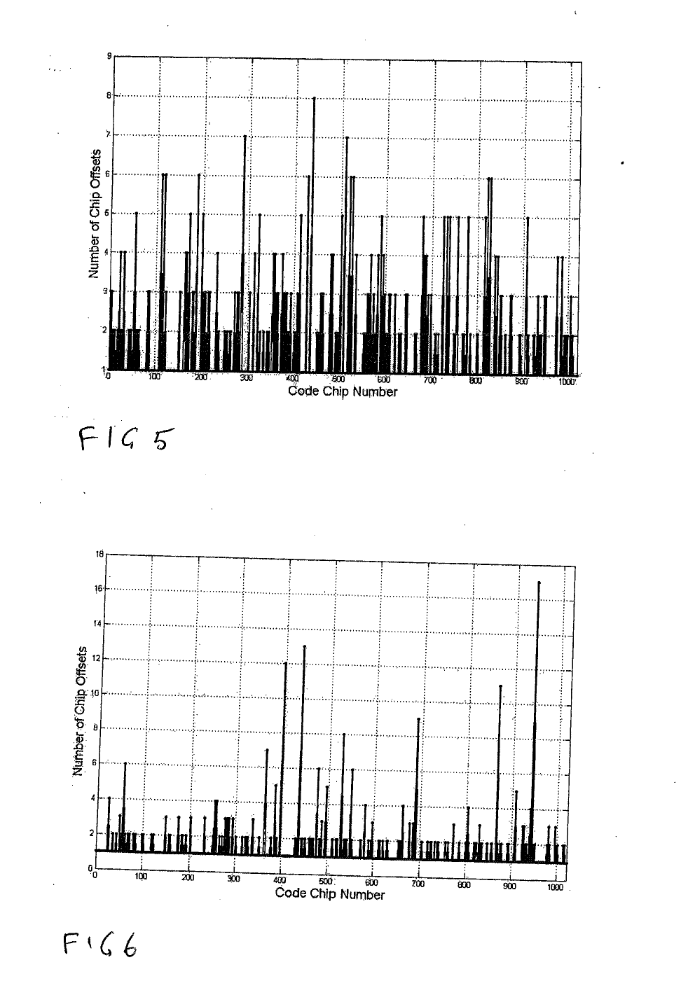

FIGS. 2, 3 and 4 illustrate typical C/A code correlation properties. FIG. 2 is a graph of correlation amplitude shows the autocorrelation performance of PRN 1. This graph of correlation amplitude versus delay (C/A code phase). As shown in FIG. 2, a peak correlation 210 of 1023 exists when the codes are aligned. FIG. 3 shows the cross correlation between PRNs 1 and 2 when there is no carrier frequency offset. As can be seen, the greatest magnitude of these cross-correlations is at least 24 dB less than the 1023 peak autocorrelation value shown in FIG. 2.

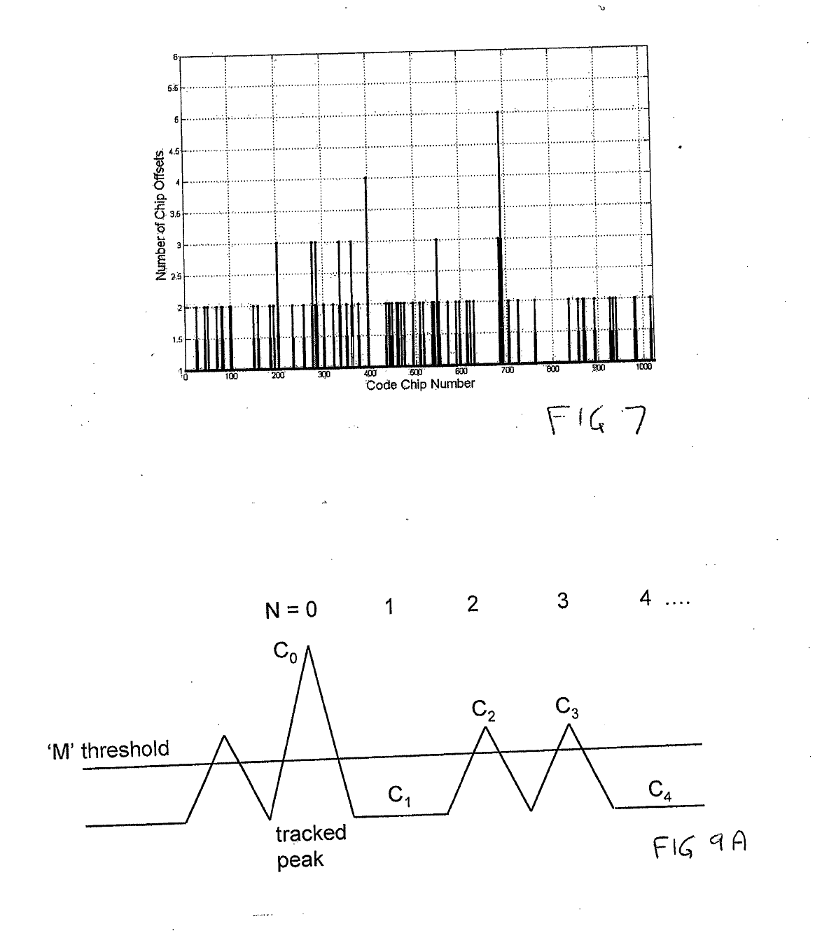

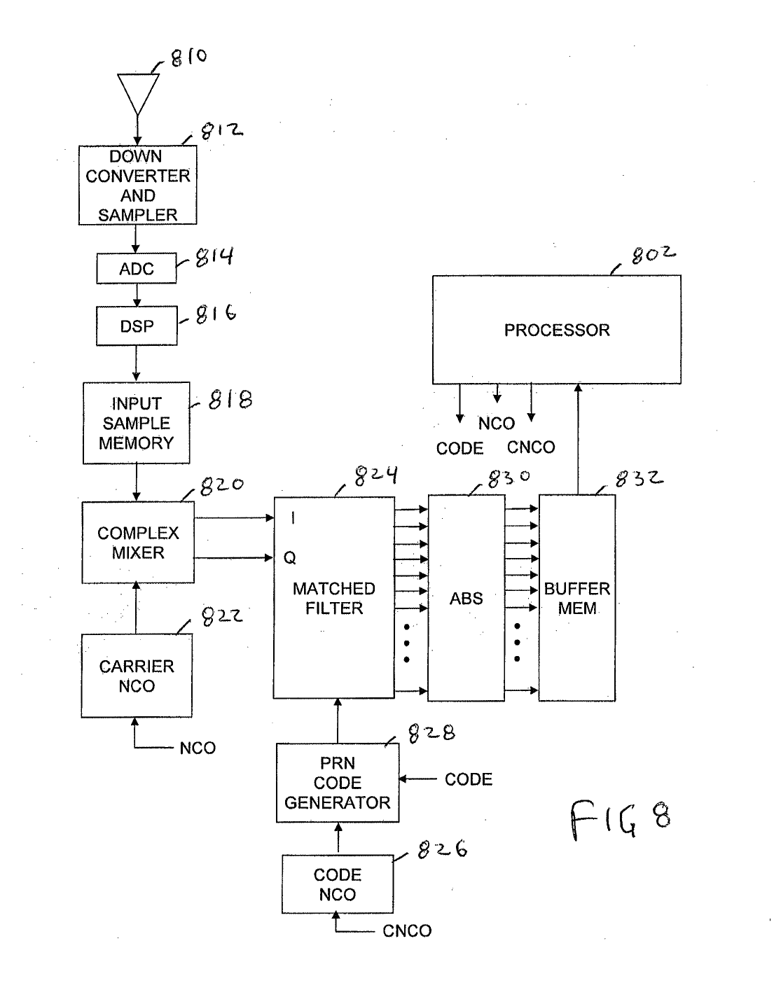

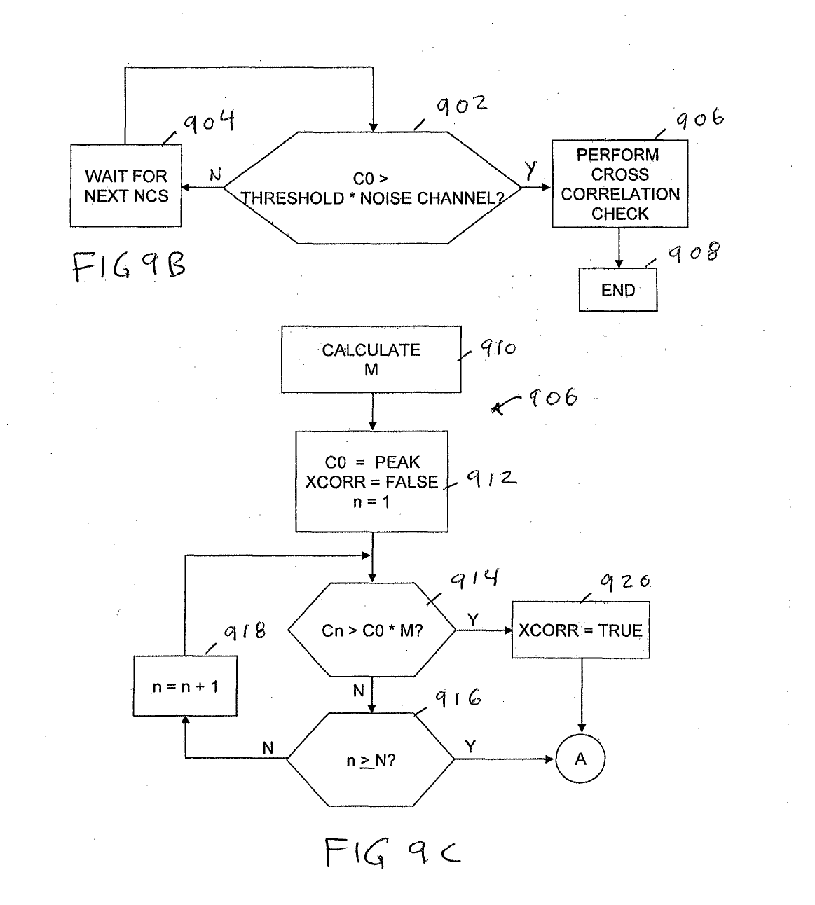

FIG. 4 shows cross correlation properties between PRNs 1 and 2 when there is a 1 kHz offset in the carrier frequency of one of the satellites. The worst case cross correlation magnitude value 410 is only about 20 dB less than the autocorrelation peak value.

The cross correlation detection technique used in the example embodiments described below relies on the cross correlation properties of any two PRN codes having certain characteristics. In particular, it relies on there being a high probability of a multiple cross correlation peaks having respective magnitudes that are within a predetermined threshold of each other and that are also within a relatively small number (±N) of chip offsets of each other. As shown in FIGS. 5 through 10, the inventor has determined that these characteristics do exist for the PRN codes used by GNSS satellites and receivers.

FIG. 5 shows an example of a cross correlation between PRNs 1 and 2 with a threshold set to 6 dB below the estimated peak. FIG. 5 shows how many chip offsets (±N) separate peaks having magnitudes that are within the threshold of each other. Thus, if one peak is erroneously detected as corresponding to an alignment with a particular C/A code, based on the cross correlation of the C/A code and the actual PRN being received, FIG. 5 shows the maximum number of code phases from each such peak to another such peak having a magnitude relative to the one peak. As shown in FIG. 5, the maximum number, N, of code phases that need to be analyzed corresponds to 8 chips of the C/A code.

FIG. 6 shows an example similar to that shown in FIG. 5 except that the carrier offset of one of the PRN codes is 1 kHz. As can be seen from this Figure, although the worst-case number of code phases that need to be examined is larger (17 chips), on average, only a relatively small number of code phases need to be analyzed to detect a false lock due to cross correlation. FIG. 7 shows how the example in FIG. 6 may be improved by increasing the threshold from 6 dB to 10 dB. As shown in FIG. 7, in the worst case, a false lock is detected by analyzing a number of code phases corresponding to 5 chips.

Although the method described above detects cross correlation peaks, it may also detect false cross correlation peaks. These peaks are cases in which the receiver has locked on to a weak C/A code but, primarily due to noise effects, the algorithm erroneously identifies the peak as a cross correlation peak.

FIG. 8 is a block diagram of circuitry suitable for use as a cross correlation peak detector. The example circuitry receives satellite signals via an antenna 810. These signals are processed by RF circuitry 812 that may, for example, include a digital mixer that down-converts the satellite signals to an intermediate frequency (IF) band. An analog-to-digital converter (ADC) 814 digitizes the IF signals. The digitized signals are then processed by a digital signal processor (DSP) 816 that may, for example, filter the samples to enhance chip signals, using a chip matched filter (CMF). The DSP filter may also reduce the effects of narrowband interfering signals. The output signals provided by the DSP are stored in an input sample memory 818.

The samples from the input sample memory 818 are applied to a mixer 820 which also receives an IF carrier signal from the carrier numerically controlled oscillator (NCO) 822. The carrier NCO is controlled by microprocessor 802 to generate in-phase (I) and quadrature (Q) IF carrier signals that are compensated for known Doppler shifts of the satellite signal so that the mixer 820 synchronously demodulates satellite signal into I and Q components. The I and Q components are, in turn, applied to a matched filter 824. The matched filter 824 receives C/A code from code generator 828 which is driven by the code NCO 826. The C/A code received from the code generator forms the coefficients of the matched filter. The demodulated I and Q components are separately processed by respective matched filters to produce correlation values representing, for example, the sum of the products of the signals and the C/A code chip values.

In the example embodiment, the matched filter 824 includes a 32-bit shift register (not shown) that concurrently applies 32 different code phases respectively to 32 correlators, each code phase delayed with respect to the previous code phase by one-half chip. Each of the correlators also receives the I and Q signals provided by the mixer 820. The output signals of the matched filter are 32 sets of I and Q signals representing correlations of the input signal with the 32 respective C/A code phases covering 16 chips. These signals are applied to 32 absolute value circuits 830 that calculate A=SQRT(I²+Q²), the magnitudes of the signals provided by the matched filter. A number of the non-coherent values (A) may be accumulated for the same code phase offset to improve the effective signal to noise ratio. For example, if A is computed every 20 milliseconds for each of 32 code phase offsets then they may be further accumulated to form 32 code phase offsets every 1 second by accumulating each 20 msec code phase offset with itself.

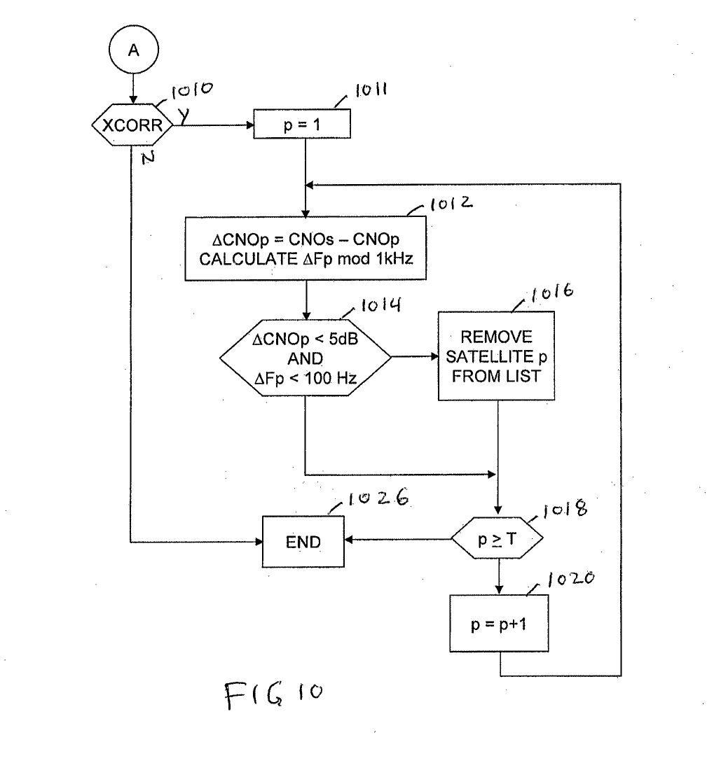

The output signals of the absolute value circuits 830 are applied to a buffer memory that stores the respective values for analysis by the microprocessor 802. The microprocessor analyzes the data in the buffer memory 832 according to the algorithm shown in FIG. 9C.

As described above, the inventor has determined that a cross correlation peak will have secondary peak, within a few chip delays of the main peak, that is close in magnitude to the main peak. In the embodiments described below, the magnitude difference between the main peak and the secondary peak that indicates that the main peak is a cross correlation is a number of decibels. The trade-off between cross correlation detection (correctly detecting the presence of a cross correlation track) and false cross correlation detection (indicating cross correlation detection when in fact the correct signal is being tracked) may be analyzed via simulation, including the presence of random noise. The variants in the simulation include the threshold M, the number of correlation offsets used N and the signal to noise ratio of the received signals. FIG. 9A shows an example peak that is being tracked by the system shown in FIG. 8. The processor 802 has analyzed the peak values in the buffer memory 832 and determined that the peak C0 is a is a satellite having the C/A code provided by the code generator 828. As shown in FIG. 9A, it is likely that the detected peak is not related to the identified satellite but, instead, is a cross correlation peak because there are peaks at C2 and C3 which are within a threshold M of the tracked main peak.

The values N and M may be different for different non-coherent integration summation (NCS) periods. Longer NCS periods typically result in higher signal-to-noise ratios. An early termination algorithm may be used to determine whether a decision should be made. In general if the received SNR is higher a decision about whether cross correlation is detected can be made more rapidly. Keeping the Pd (probability of detect) and Pfa (probability of false alarm) within reason. An example early termination algorithm is shown in FIG. 9B.

Step 902 of FIG. 9B compares the peak C0 to an early termination threshold value multiplied by a measure of noise provided in a noise channel. If the detected peak, C0, is greater than this value, the signal-to-noise ratio is sufficient to perform the cross correlation check at step 906. The algorithm used for the cross correlation check is shown in FIG. 9C, described below. After step 906 of FIG. 9B, the process ends at step 908 and is invoked again when a new potential peak value, C0, is found. If the condition at step 902 is not met, then step 904 of the algorithm is executed which waits for the next NCS period and branches back to step 902 to determine if the signal-to-noise ratio is sufficient based on the correlation values provided by the correlation of the additional samples. Example values for NCS number, NCS time and Threshold for the algorithm shown in FIG. 9B as well as for N and M in the algorithm shown in FIG. 9C are given in the following Table.

TABLE

| NCS # × | NCS Time | Early Termination | | |
|---|---|---|---|---|
| 20 ms | (ms) | Threshold | M | N |
| 8 | 160 | 2.70 | 1/1.6 | 6 |
| 16 | 320 | 2.45 | 1/1.6 | 6 |
| 32 | 640 | 2.05 | 1/1.5 | 6 |
| 64 | 1280 | 1.88 | 1/1.5 | 6 |
| 128 | 2560 | 1.64 | 1/1.4 | 5 |
| 256 | 5120 | 1.31 | 1/1.2 | 4 |
| 512 | 10240 | 1.18 | 1/1.1 | 4 |
| 1024 | 20480 | 1.09 | 1/1.05 | 4 |

The process in FIG. 9C is an example cross correlation check 906 from FIG. 9B. The process, which is tracking satellite S, begins at step 910 which calculates a value M according to the Table. Next, at step 912, the process sets C0 to the value of the main peak detected by the processor 802 from the values stored in the buffer memory 832. Step 912 also sets a Boolean variable XCORR to false and an index variable n to 1. At step 914, the process tests the peak at chip phase Cn according to the inequality (1)

Cn>C0*M (1)

This step determines if the value at chip phase Cn is within the threshold M of the main peak C0. If it is, then cross correlation has been detected and, at step 920, the process sets the variable XCORR to True. Once one peak that is within the threshold M of the main peak has been identified, the process transfers control to step A, described below with reference to FIG. 10.

If, at step 914, the process determines that the stored value at chip delay Cn is not within the threshold M of the main peak C0, control transfers to step 916 which determines if all of the chip delays in the buffer memory 832 have been checked. If they have not then, at step 918, the value n is incremented and control is transferred to step 914 to test the value stored at the next chip delay.

The process shown in FIG. 9C analyzes the correlation values at each of the N chip delay offsets relative to the main peak until a value within the threshold of the main value is detected. The value of N may be obtained from the Table. Because multipath distortion may result in additional peaks, it may be desirable not to analyze every chip delay but to limit the tested chip delays to those that are more than one or two chip delays from the main peak. This modification of the algorithm shown in FIG. 9C should be sufficient to avoid the detection of multipath peaks as these are typically close in time to the main peak.

If the process in FIG. 9C detects a cross correlation, other cross correlation peaks may also exist among the detected satellites. The inventor has determined that these cross correlations will have characteristics similar to the detected cross correlation satellite. In particular, their signal to noise ratios will be similar and their frequencies will be approximately at one kHz intervals relative to the frequency of the detected cross correlation signal. This second characteristic occurs because the cross correlation signals are linked to the C/A codes that repeat with a period of 1 ms. The inventor has determined that, if these two criteria are met by any of the detected satellites then detected peaks for these satellites are also cross correlation peaks.

Thus, if a cross correlation is detected by the process shown in FIG. 9C, the process in FIG. 10 may be applied to all of the other detected satellites to determine if any of those satellites may also be cross correlations with the same strong satellite signal. This process steps through all of the detected satellites, 1 to T, and compares the signal to noise ratio and carrier frequency of the satellite to that of the detected cross correlation satellite.

The first step in the process, 1010, tests the value XCORR. If this value is False, then no cross correlation peaks were detected in the process of FIG. 9C and the process ends at step 1026. If XCORR is True, at step 1010, then the process in FIG. 9C identified satellite S as having been erroneously detected based on a cross correlation peak. The process, at step 1012, sets a temporary variable p to 1, calculates the values ΔCN0p and ΔFp (i.e. the signal to noise differential for the signal of satellite p and the differential frequency modulo 1 kHz for satellite p) according to equations (2) and (3).

ΔCN0p=CN0s−CN0p (2)

ΔFp=(Fp−Fs) modulo 1 kHz (3)

Step 1014 determines if satellite p is also a false lock caused by cross correlation by determining if ΔCN0p less than a threshold signal-to-noise difference value, for example, 5 dB, and if ΔFp is less than a threshold modulo frequency difference value, for example, 100 Hz. These values are provided only as examples and it is contemplated that other values may be used. If these two conditions are met, then at step 1016, the process removes satellite p from the list of detected satellites. If, at step 1014, the two criteria were not satisfied or after step 1016, step 1018 determines that the last satellite has been processed and, if it has, the process ends at step 1026. If step 1018 determines that the last satellite has not been processed then, at step 1020, p is incremented and control is transferred to step 1014 to determine if the next satellite in the list is a true satellite or a false lock based on a cross correlation.

The process shown in FIG. 10 will remove all satellites that were detected based on cross correlations from the list of detected satellites. This includes satellite S that was identified by the algorithm of FIG. 9C as being a false lock because it will necessarily meet the criteria of equations (2) and (3).

The embodiments described above may be relatively easy to implement in existing GPS devices because these devices typically include several code phase offsets in their tracking data in order to detect continuous wave (CW) interfering signals or for far multipath detection. Thus, the described method may be implemented by adding a small amount of software to an existing GPS system.

The embodiments described above detect erroneous cross correlation satellite locks during satellite tracking. It is contemplated that a similar method may be applied during the acquisition phase to prevent the initial acquisition of a satellite based on a cross correlation. During satellite acquisition, several hypotheses are tested for each C/A code. In order to detect cross correlation, the algorithm shown in FIG. 9C may be applied to each hypothesis.

The invention has been described in terms of example embodiments. It is contemplated that it may be practiced as described above with modifications within the scope of the following claims.

What is claimed:

1. A method for identifying a false correlation between a first pseudo random noise (PRN) code and a second PRN code, each of the first and second PRN codes being defined by a respectively different pseudo-random sequence of chips, the method comprising:
correlating the first PRN code to the second PRN code to produce a plurality of correlation values spanning N chips;
identifying a main peak correlation value in the plurality of correlation values;
calculating a threshold value based on the identified main peak;
comparing each of the plurality of correlation values within N code chips of the main peak correlation value to the threshold value, where N is an integer; and
identifying the main peak correlation value as a false correlation if one of the plurality of correlation values other than the main peak correlation value exceeds the threshold value.

2. The method according to claim 1, wherein calculating the threshold value comprises multiplying the peak value by a value M, where M represents a number of decibels by which the other correlation value may differ from the peak value.

3. The method according to claim 1, wherein the first PRN code is a first coarse acquisition (C/A) code of a received satellite signal and the second PRN code is second C/A code, different from the first C/A code, generated in a satellite receiver.

4. The method according to claim 3, wherein the satellite signal is a Quasi-Zenith Satellite System (QZSS) signal.

5. The method according to claim 3, wherein the satellite signal modulates a carrier signal and the carrier signal has a Doppler offset of at least 1 kHz.

6. The method according to claim 3, further including:
a) accumulating a non-coherent summation (NCS) of the first PRN code over an accumulation time period;
b) calculating a signal-to-noise ratio for the accumulated PRN code;
c) if the signal-to noise ratio for the accumulated PRN code is less than a threshold value, then increasing the accumulation time period in length and repeating steps a), b) and c) for the increased accumulation time period; and
d) if the signal to noise ratio for the accumulated PRN code is greater than the threshold value, setting N and M based on the length of the accumulation time period.

7. A method for detecting a false correlation between a Global Navigation Satellite System (GNSS) satellite signal having a first pseudo-random noise (PRN) code and a coarse acquisition (C/A) code of a GNSS receiver, having a second PRN code different from the first PRN code, the method comprising:
demodulating the GNSS satellite signal to recover the first PRN code;
filtering the first PRN code in a plurality of matched filters, each matched having filter coefficients corresponding to the second PRN code, the coefficients of successive matched filters being offset, to generate a plurality of correlation values;
identifying a main peak in the plurality of correlation values;
calculating a threshold value based on the identified main peak;
comparing each of the plurality of correlation values to the threshold value; and
identifying the correlation peak as a false correlation if one of the plurality of correlation values exceeds the threshold value.

8. the method according to claim 7 wherein the GNSS satellite signal is one of T GPS satellite signals identified by the GNSS receiver and the method further comprises:
for each of the T satellite signals:
determining a signal-to-noise level of each of the satellite signals relative to the satellite signal corresponding to the false correlation peak;
determining a carrier frequency offset modulo 1 kHz for each of the T satellite signals relative to the carrier signal of the satellite signal corresponding to the false correlation peak;
for each of the T satellite signals, identifying the satellite signal as an invalid satellite signal if the relative signal to noise ratio is less than a first threshold value and the carrier frequency offset modulo 1 kHz is less than a second threshold value.

9. The method according to claim 7, wherein the GNSS receiver is a GPS receiver and the GNSS satellite signal is a Quasi-Zenith Satellite System (QZSS) signal.

10. The method according to claim 7, wherein the GNSS satellite signal modulates a carrier signal and the carrier signal has a Doppler offset of at least 1 kHz.

11. The method according to claim 7, further including:
a) accumulating a non-coherent summation (NCS) of the first PRN code over an accumulation time period;
b) calculating a signal-to-noise ratio for the accumulated PRN code;
c) if the signal-to noise ratio for the accumulated PRN code is less than a threshold value, then increasing the accumulation time period in length and repeating steps a), b) and c) for the increased accumulation time period; and
d) if the signal to noise ratio for the accumulated PRN code is greater than the threshold value, setting N and M based on the length of the accumulation time period.

12. The method according to claim 7, where N is between 4 and 16.

13. The method according to claim 7, where M is between 0.5 and 1.0.

14. A Global Navigation Satellite System (GNSS) receiver comprising:
a demodulator which demodulstes the GNSS satellite signal to recover a first pseudo random noise (PRN) code;
a PRN code generator which generates a second PRN code;
a matched filter which filters the first PRN code in a plurality of matched filters, each matched having filter coefficients corresponding to the second PRN code, the coefficients of successive matched filters being offset, to generate a plurality of correlation values and for storing the correlation values in a buffer memory;
a processor configured to:
identify a main peak in the plurality of correlation values;
calculate a threshold value based on the identified main peak;
compare each of the plurality of correlation values to the threshold value;
compare each of the plurality of correlation values to the threshold value; and
identify the correlation peak as a false correlation if one of the plurality of correlation values exceeds the threshold value.

15. the GNSS receiver of claim 14 wherein the GNSS satellite signal is one of T GPS satellite signals identified by the GNSS receiver and, for each of the T satellites, the processor is further configured to:
determine a signal-to-noise level of each of the satellite signals relative to the satellite signal corresponding to the false correlation peak;
determine a carrier frequency offset modulo 1 kHz for each of the T satellite signals relative to the carrier signal of the satellite signal corresponding to the false correlation peak;
identify the satellite signal as an invalid satellite signal if the relative signal to noise ratio is less than a first threshold value and the carrier frequency offset modulo 1 kHz is less than a second threshold value.

16. The GNSS receiver of claim 14, wherein the GNSS receiver is a GPS receiver and the GNSS satellite signal is a Quasi-Zenith Satellite System (QZSS) signal.

17. The GNSS receiver of claim 14, wherein the GNSS satellite signal modulates a carrier signal and the carrier signal has a Doppler offset of at least 1 kHz.

18. The GNSS receiver of claim 14, wherein the processor is further configured to:
accumulate a non-coherent summation (NCS) of the first PRN code over an accumulation time period;
calculate a signal-to-noise ratio for the accumulated PRN code;
if the signal-to noise ratio for the accumulated PRN code is less than a threshold value, then increasing the accumulation time period in length and repeating the accumulate and calculate steps for the increased accumulation time period; and
if the signal to noise ratio for the accumulated PRN code is greater than the threshold value, setting N and M based on the length of the accumulation time period.

19. The GNSS receiver of claim 14, where N is between 4 and 16.

20. The GNSS receiver of claim 14, where M is between 0.5 and 1.0.
